(19) United States
(12) Patent Application Publication
(10) Pub. No.: US 2025/0131736 A1
(43) Pub. Date: Apr. 24, 2025

(54) METHOD AND APPARATUS WITH OBJECT DETECTION

(71) Applicant: Samsung Electronics Co., Ltd., Suwon-si (KR)

(72) Inventors: Jaeseok CHOI, Suwon-si (KR); Dongwook LEE, Suwon-si (KR); ByeongJu LEE, Suwon-si (KR); Younghwa JUNG, Suwon-si (KR); Young Rae CHO, Suwon-si (KR)

(73) Assignee: Samsung Electronics Co., Ltd., Suwon-si (KR)

(21) Appl. No.: 18/612,385

(22) Filed: Mar. 21, 2024

(30) Foreign Application Priority Data
Oct. 19, 2023 (KR) 10-2023-0140553

(51) Int. Cl. G06V 20/58; G06V 10/77

(52) U.S. Cl. CPC G06V 20/58; G06V 10/7715

(57) ABSTRACT

A processor-implemented method with object recognition includes obtaining sensor data comprising points representing a surrounding environment of a sensor, detecting, from the sensor data, a shaded region in which the points are not generated due to occlusion by a surrounding object, generating feature data using the shaded region, and performing object recognition for the surrounding environment of the sensor based on the feature data.

### CROSS-REFERENCE TO RELATED APPLICATIONS

This application claims the benefit under 35 USC § 119 (a) of Korean Patent Application No. 10-2023-0140553 filed on Oct. 19, 2023 in the Korean Intellectual Property Office, the entire disclosure of which is incorporated herein by reference for all purposes.

### BACKGROUND

### 1. Field

The following description relates to a method and apparatus with object detection.

### 2. Description of Related Art

Technical automation of a recognition process may be implemented through a neural network model implemented, for example, by a processor as a special computing structure. The neural network model may provide intuitive mapping for computations between an input pattern and an output pattern after considerable training. Such a trained capability of generating the mapping may be referred to as a learning ability of the neural network model. Furthermore, a neural network model trained and specialized through special training may have, for example, a generalization ability to provide a relatively accurate output with respect to an untrained input pattern.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with object recognition includes: obtaining sensor data comprising points representing a surrounding environment of a sensor; detecting, from the sensor data, a shaded region in which the points are not generated due to occlusion by a surrounding object; generating feature data using the shaded region; and performing object recognition for the surrounding environment of the sensor based on the feature data.

The feature data may be generated using a reference area comprising at least a portion of the shaded region.

The generating of the feature data may include: determining a reference area comprising at least a portion of the shaded region; generating second sub-feature data corresponding to the reference area using a deep learning model; and generating the feature data by merging the second sub-feature data with first sub-feature data corresponding to the points of the sensor data.

The generating of the second sub-feature data may include: determining a target point in the reference area; generating reference data based on a geometric relationship between reference points in the reference area among the points and the target point; and generating the second sub-feature data by executing the deep learning model based on the reference data.

The generating of the reference data may include generating the reference data based on relative coordinates between the reference points and the target point.

The detecting of the shaded region may include: aligning the points according to a distance between a sensor point corresponding to the sensor and each of the points; and detecting the shaded region based on either one or both of a change in elevation of the points and an interval between the points.

The detecting of the shaded region may include: dividing a virtual space corresponding to the surrounding environment of the sensor into segments; determining shaded region candidates having a possibility to be the shaded region based on the segments; and determining the shaded region based on the shaded region candidates.

The determining of the shaded region candidates may include: aligning the points according to a distance between a sensor point corresponding to the sensor and each of the points; determining starting points based on either one or both of a change in elevation of the points and an interval between the points; and determining the shaded region candidates in, among the segments, segments in which the starting points are included.

The determining of the shaded region may include determining the shaded region by merging two or more of the shaded region candidates based on a geometric relationship between the starting points.

The method may include determining a distance between the sensor point and a starting point of the shaded region based on an average of distances between the sensor point and starting points of the two or more of the shaded region candidates.

In one or more general aspects, a non-transitory computer-readable storage medium may store instructions that, when executed by one or more processors, configure the one or more processors to perform any one, any combination, or all of operations and/or methods described herein.

In one or more general aspects, an electronic device includes: one or more processors configured to: obtain sensor data comprising points representing a surrounding environment of a sensor; detect, from the sensor data, a shaded region in which the points are not generated due to occlusion by a surrounding object; generate feature data using the shaded region; and perform object recognition for the surrounding environment of the sensor based on the feature data.

The feature data may be generated using a reference area comprising at least a portion of the shaded region.

For the generating of the feature data, the one or more processors may be configured to: determine a reference area comprising at least a portion of the shaded region; generate second sub-feature data corresponding to the reference area using a deep learning model; and generate the feature data by merging the second sub-feature data with first sub-feature data corresponding to the points of the sensor data.

For the generating of the second sub-feature data, the one or more processors may be configured to: determine a target point in the reference area; generate reference data based on a geometric relationship between reference points in the reference area among the points and the target point; and generate the second sub-feature data by executing the deep learning model based on the reference data.

For the detecting of the shaded region, the one or more processors may be configured to: align the points according to a distance between a sensor point corresponding to the sensor and each of the points; and detect the shaded region based on either one or both of a change in elevation of the points and an interval between the points.

For the detecting of the shaded region, the one or more processors may be configured to: divide a virtual space corresponding to the surrounding environment of the sensor into segments; determine shaded region candidates having a possibility to be the shaded region based on the segments; and determine the shaded region based on the shaded region candidates.

For the determining of the shaded region candidates, the one or more processors may be configured to: align the points according to a distance between a sensor point corresponding to the sensor and each of the points; determine starting points based on either one or both of a change in elevation of the points and an interval between the points; and determine the shaded region candidates in, among the segments, segments in which the starting points are included.

For the determining of the shaded region, the one or more processors may be configured to determine the shaded region by merging two or more of the shaded region candidates based on a geometric relationship between the starting points.

In one or more general aspects, a vehicle includes: a sensor configured to generate sensor data comprising points representing a surrounding environment of a sensor; one or more processors configured to: detect, from the sensor data, a shaded region in which the points are not generated due to occlusion by a surrounding object; generate feature data using the shaded region; and perform object recognition for the surrounding environment of the sensor based on the feature data; and a control system configured to control the vehicle based on a result of the object recognition.

Other features and aspects will be apparent from the following detailed description, the drawings, and the claims.

### BRIEF DESCRIPTION OF THE DRAWINGS

FIG. 1 illustrates an example of a shaded region caused by surrounding objects.

FIG. 2 illustrates a flowchart of an example of an object recognition method using a shaded region.

FIG. 3 illustrates an example of a shaded region.

FIG. 4 illustrates an example of segments of a virtual space.

FIG. 5 illustrates an example of a process of detecting a shaded region.

FIG. 6 illustrates an example of a process of merging shaded region candidates.

FIG. 7 illustrates an example of a reference area.

FIG. 8 illustrates an example of a process in which an object recognition result is generated from sensor data.

FIG. 9 illustrates an example of an object recognition process based on point voxelization.

FIG. 10 illustrates an example of a process in which an object recognition result is generated from sensor data.

FIG. 11 illustrates an example of an object recognition process based on point sampling.

FIG. 12 illustrates an example of a configuration of an electronic device.

FIG. 13 illustrates an example of a configuration of a vehicle.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meanings as those commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples are described in detail with reference to the accompanying drawings. When describing the examples with reference to the accompanying drawings, like reference numerals refer to like components and a repeated description related thereto is omitted.

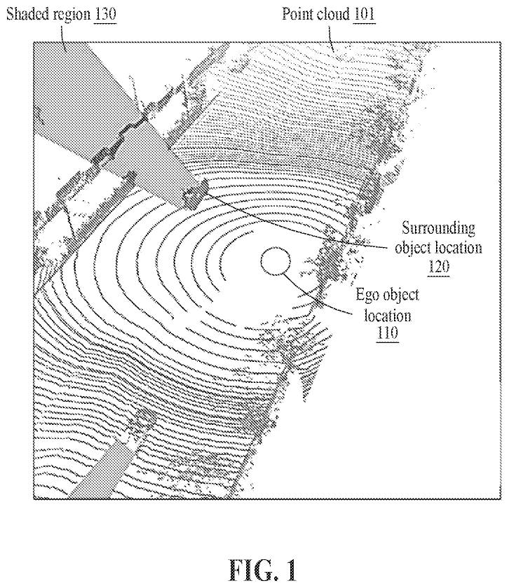

FIG. 1 illustrates an example of a shaded region caused by a surrounding object. Referring to FIG. 1, a point cloud 101 may include points representing a surrounding environment of an ego object. The point cloud 101 may be generated using a sensing method such as light detection and ranging (LiDAR). A large number of points may be generated with an ego object location 110 as a result of sensor measurement, and information on a surrounding environment of the ego object such as a surrounding object location 120 may be obtained by analyzing the points.

The ego object may refer to an object on which a sensor that generates the point cloud 101 is installed. The surrounding environment may refer to objects located close to the ego object appearing in the point cloud 101, and the surrounding object may refer to an object located close enough to the ego object to appear in the point cloud 101. The ego object and the surrounding object may correspond to any device capable of recognizing the surrounding environment using a sensor (e.g., LiDAR), such as a vehicle, robot, closed-circuit television (CCTV), and/or mobile device.

The surrounding object may cause occlusion of a sensing path. For example, LiDAR may generate points of the point cloud 101 using light, and surrounding objects located in the path of the light may block the progress of the light. When occlusion of the sensing path occurs as described above, a shaded region 130, in which points are not generated, may appear in the point cloud 101. The shaded region 130 may be a type of a void space. A space in the point cloud 101 that does not include points may be referred to as a void space. Among void spaces due to various causes, the shaded region 130 may correspond to a void space caused by occlusion.

When the points of the point cloud 101 cannot express every change in intensity according to a signal progression angle and the shapes of various objects in the real world, recognition performance may deteriorate when only the points are used for object recognition. When the shaded region 130 appears behind the surrounding object like a shadow, there may not be a significant change in the intensity according to the signal progression angle and the shape of the surrounding object, and recognition performance may be improved through using the shaded region 130. Utilizing all void spaces for object recognition may require a high amount of computations. Since the shaded region 130 includes information on the surrounding object, a method and apparatus of one or more embodiments may reduce the amount of computations used for object recognition and may increase computation efficiency at the same time by selectively using the shaded region 130 among the void spaces.

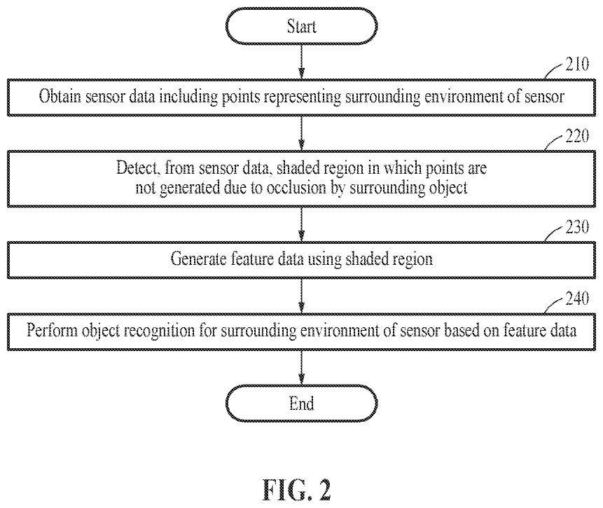

FIG. 2 illustrates a flowchart of an example of an object recognition method using a shaded region. Referring to FIG. 2, an electronic device may obtain sensor data including points representing a surrounding environment of a sensor in operation 210. For example, the sensor may be LiDAR. The sensor may be included in an electronic device and/or may be included in an ego object (e.g., an ego vehicle) including an electronic device. The sensor data may be generated based on an output of the sensor. The output of the sensor may include a point cloud. Points of the sensor data may be points of the point cloud and/or voxelized points obtained by voxelization of points of the point cloud.

In operation 220, the electronic device may detect, from the sensor data, a shaded region in which points are not generated due to occlusion by a surrounding object. The electronic device may align the points according to the distance between a sensor point corresponding to the sensor and each of the points and may detect the shaded region based on a change in elevation of the points, an interval between the points, and/or a combination thereof.

In operation 220, the electronic device may divide a virtual space corresponding to the surrounding environment of the sensor into segments, may determine shaded region candidates that may be the shaded region based on the segments, and may determine the shaded region based on the shaded region candidates. The electronic device may align the points according to the distance between the sensor point corresponding to the sensor and each of the points, may determine starting points based on the change in the elevation of the points, the interval between the points, and/or a combination thereof, and may determine the shaded region candidates in, among the segments, segments in which the starting points are included. The electronic device may determine the shaded region by merging at least two of the shaded region candidates based on a geometric relationship between the starting points.

In operation 230, the electronic device may generate feature data using the shaded region. The feature data may be generated using a reference area that includes at least a portion of the shaded region. The electronic device may determine the reference area including at least a portion of the shaded region, may generate second sub-feature data corresponding to the reference area using a deep learning model, and may generate the feature data by merging the second sub-feature data with first sub-feature data corresponding to the points of the sensor data. The electronic device may determine a target point in the reference area, may generate reference data based on a geometric relationship between reference points in the reference area among the points and the target point, and may generate the second sub-feature data by executing the deep learning model based on the reference data. The electronic device may generate the reference data based on relative coordinates between the reference points and the target point.

In operation 240, the electronic device may perform object recognition for the surrounding environment of the sensor based on the feature data. The object recognition may include object classification, object identification, object detection, object tracking, and/or a combination thereof. The electronic device may recognize an object of a desired category. For example, the electronic device may generate a map image corresponding to the sensor data, may recognize the surrounding object (e.g., a vehicle, people, an obstacle, etc.) in the map image, and may place a bounding box on the recognized surrounding object.

An object recognition result may be used for controlling the ego object. For example, when the ego object has the ability to move, such as in the cases of a vehicle and/or robot, the object recognition result may be used for autonomous movement of the ego object. In another example, when the ego object corresponds to a CCTV, the object recognition result may be used in detecting an intruder and activating a user alarm to prevent the intruder from entering.

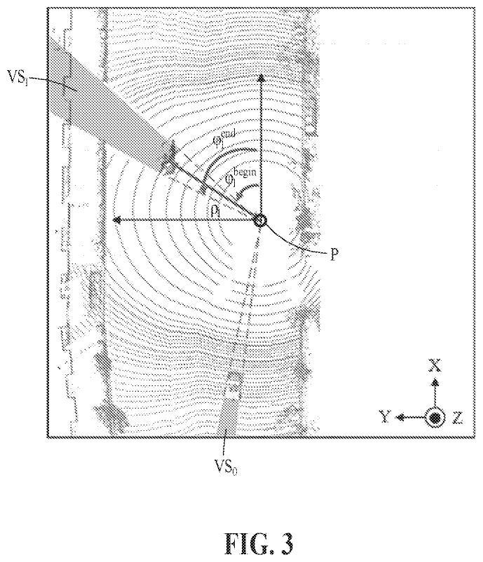

FIG. 3 illustrates an example of a shaded region. Referring to FIG. 3, shaded regions VS₀ and VS₁ are shown. A shaded region may be defined as in Equation 1 below, for example.

$${VS}_{k} = \{ {ρ}_{k} , {φ}_{k}^{begin} , {φ}_{k}^{end} \} \qquad Equation 1$$

The shaded region may be expressed using a cylindrical coordinate system. When the sensor data is based on a Cartesian coordinate system, the sensor data may be converted to the cylindrical coordinate system. When performing object recognition using a shaded region, the method and apparatus of one or more embodiments may use the cylindrical coordinate system as the cylindrical coordinate system may be more efficient than the Cartesian coordinate system. In Equation 1, VSₖ denotes a k-th shaded region, ρₖ denotes the distance between the k-th shaded region and a sensor point P, ϕₖ^{begin} denotes a starting angle of the k-th shaded region, and ϕₖ^{end} denotes an ending angle of the k-th shaded region.

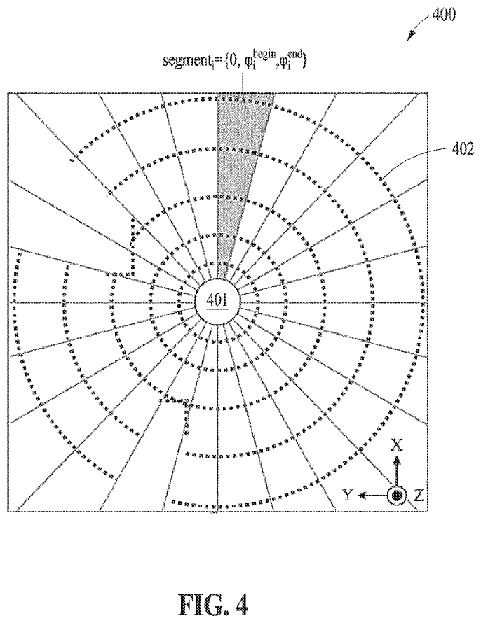

FIG. 4 illustrates an example of segments of a virtual space. Referring to FIG. 4, a map image 400 representing a virtual space corresponding to a surrounding environment of a sensor may be generated based on sensor data. The map image 400 may include a point 402 measured from a sensor point 401 corresponding to a sensor location. The map image 400 may be divided into segments (e.g., where each segment is bound by adjacent lines extending from the sensor point 401). An i-th segment may be expressed as in Equation 2 below, for example, based on Equation 1 above.

$${segment}_{i} = \{ 0 , {φ}_{i}^{begin} , {φ}_{i}^{end} \} \qquad Equation 2$$

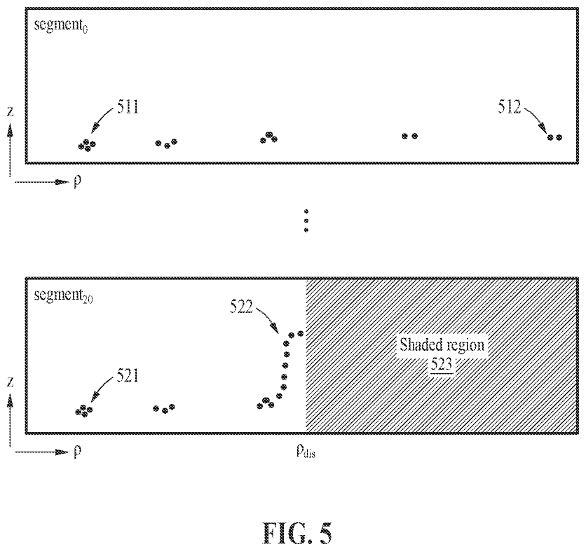

FIG. 5 illustrates an example of a process of detecting a shaded region. The shaded region may be detected using segments. Referring to FIG. 5, shaded region detection may be performed from segment₀ to segment₂₀. However, the number of segments is not limited to 20 and, according to other non-limiting examples, the number of segments may be less or more than 20. Points may be aligned according to the distance between a sensor point corresponding to a sensor and each of the points. The shaded region may be detected based on a change in elevation of the points, an interval between the points, and/or a combination thereof.

As shown in FIG. 5, points from segment₀ to segment₂₀ may be aligned in order of distance from the sensor. The smaller ρ may correspond to points closer to the sensor. z may represent the elevation of the points. In the case of segment₀, from the points of a first point group 511 to the points of a last point group 512, the points have similar intervals between adjacent point groups, and no points have a particularly high elevation. In the case of segment₂₀, points of a third point group 522 have a high elevation unlike points of a first point group 521. In addition, when points after a third point group 522 are not displayed, it may be determined that the interval between the points of the third point group 522 and points of a fourth point group (not shown) may be far greater than the intervals between other adjacent point groups.

As described above, a shaded region 523 may be detected in segment₂₀ based on a change in elevation of the points, the interval between the points, and/or a combination thereof. For example, when the change in elevation of the points is greater than an elevation threshold and/or when the interval between the points is greater than an interval threshold, a starting point (ρ_{dis}) of the shaded region may be determined and the shaded region 523 behind the starting point (ρ_{dis}) may be detected. When other shaded regions exist around the shaded region 523 (e.g., directly adjacent to the shaded region 523), the shaded region 523 may be merged with the other shaded regions. In order to determine whether merging is to be performed as described above, the shaded region 523 may first be set as a shaded region candidate and be set as a final shaded region after merging. Merging of shaded region candidates may be referred to as post-processing.

The shaded region 523 may be detected based on Table 1 below, for example.

TABLE 1

```
Input:
  Raw-points or voxelized-points set: P_{Cartesian}(Nₚₒᵢₙₜₛ, 4)
  Number of segments: N_{seg}
  Void Space ρ, z threshold: ρₜₕᵣₑₛₕ, zₜₕᵣₑₛₕ
  Maximum range of ρ: ρₘₐₓ
Output:
  Shaded Region candidate set: VS_{candidate}(N_{candidate}, 3)
Algorithm:
  P_{Cylindrical} ← convertCarteisanToCylindrical(P_{Cartesian})
  for i from 0 to N_{seg} do
  Pᵢ ← getSegmentPoints(P_{Cylindrical}, i)
    Pᵢ ← sort(Pᵢ)
    for j from 1 to len(Pᵢ) do
      ρ̅ₚᵣₑᵥ, z̅ₚᵣₑᵥ = calculateMovingAverage(Pᵢ, j − 1)
      ρ̅_{cur}, z̅_{cur} = calculateMovingAverage(Pᵢ, j)
      if z̅ₚᵣₑᵥ − z̅_{cur} > zₜₕᵣₑₛₕ or ρ̅ₒᵤᵣ − ρ̅ₚᵣₑᵥ > ρₜₕᵣₑₛₕ then
        save {ρᵢⱼ, φᵢ^{begin}, φᵢ^{end}} to VS_{candidate}
        break
      end if
    end for
    if j == len(Pᵢ) and ρₘₐₓ−ρ̅ₒᵤᵣ > ρₜₕᵣₑₛₕ then
      save {ρᵢⱼ, φᵢ^{begin}, φᵢ^{end}} to VS_{candidaite}
    end if
  end for
  return VS_{candidaite}
```

According to Table 1, when the point set (P_{Cartesian}), the number of segments (N_{seg}), the shaded region thresholds (ρₜₕᵣₑₛₕ and zₜₕᵣₑₛₕ), and the maximum distance (ρₘₐₓ) are input, the algorithm of Table 1 may be performed and a shaded region candidate set (VS_{candidate}) may be output. Nₚₒᵢₙₜₛ may represent the number of points of the point set, and N_{candidate} may represent the number of shaded region candidates in the shaded region candidate set (VS_{candidate}). “4” and “3” may represent the length of each piece of data. According to the algorithm, the points of each segment may be obtained, the points may be aligned, and a moving average of the interval and elevation may be compared to the shaded region thresholds so that the shaded region candidate set (VS_{candidate}) may be determined. In addition, the shaded region candidate set (VS_{candidate}) may be determined based on a moving average of the interval of points around the maximum distance.

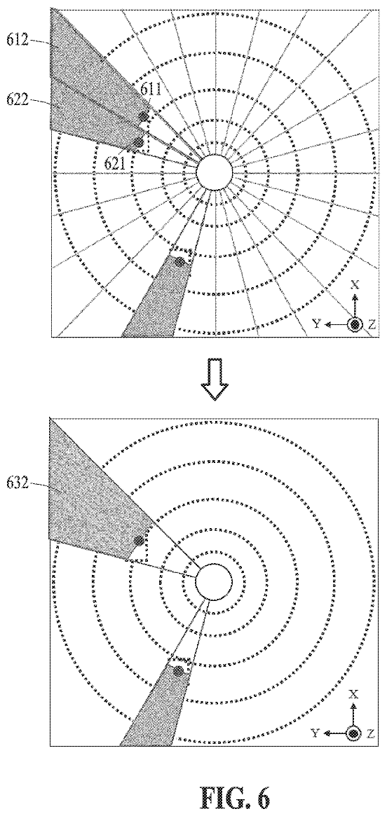

FIG. 6 illustrates an example of a process of merging shaded region candidates. Referring to FIG. 6, a first shaded region candidate 612 may be detected based on a first starting point 611 and a second shaded region candidate 622 may be detected based on a second starting point 621. When the first shaded region candidate 612 and the second shaded region candidate 622 are due to occlusion by the same surrounding object, the first shaded region candidate 612 and the second shaded region candidate 622 may be merged with each other. The first shaded region candidate 612 and the second shaded region candidate 622 may be merged with each other based on a geometric relationship between the first starting point 611 and the second starting point 621. For example, when the difference between a distance value (ρ_{dis1}) of the first starting point 611 (e.g., a distance between the first starting point 611 and a sensor point) and a distance value (ρ_{dis1}) of the second starting point 621 (e.g., a distance between the second starting point 621 and the sensor point) is less than a merging threshold, the first shaded region candidate 612 and the second shaded region candidate 622 may be merged with each other. A shaded region 632 may be determined by merging the first shaded region candidate 612 with the second shaded region candidate 622. In a non-limiting example, a distance value of a starting point of the shaded region 632 may be determined to be an average of the distance value (ρ_{dis1}) of the first starting point 611 and the distance value (ρ_{dis1}) of the second starting point 621.

The shaded region candidates may be merged based on Table 2 below, for example.

TABLE 2

```
Input:
  Shaded Region candidate set: VS_{candidate}(N_{candidate}, 3)
  Connected Shaded Region ρ threshold: ρ_{merge}_{_{—}}ₜₕᵣₑₛₕ
Output:
  Final Shaded Region set: VS(Nᵥₛ, 3)
Algorithm:
  save VS_{candidate}[0] to VS
  for i from 1 to N_{candidate} do
    if |VS_{candidate}[i, 0] − VS_{candidate}[i − 1, 0]| ≤ ρ_{merge}_{_{—}}ₜₕᵣₑₛₕ then
  VS[−1, 2] = VS_{candidate}[i, 2]
    else
      save VS_{candidate}[i] to VS
    end if
  end for
  return VS
```

According to Table 2, when the shaded region candidate set (VS_{candidate}) and the merging threshold (ρ_{merge_thresh}) are input, the algorithm of Table 2 may be performed and a final shaded region set (VS) may be output. N_{candidate} may represent the number of shaded region candidates and N_{VS} may represent the number of final shaded regions. “3” may represent the length of each piece of data. According to the algorithm, the difference between the distances of the shaded region candidates to a starting point may be compared to the merging threshold, and the final shaded region may be determined according to the comparison result.

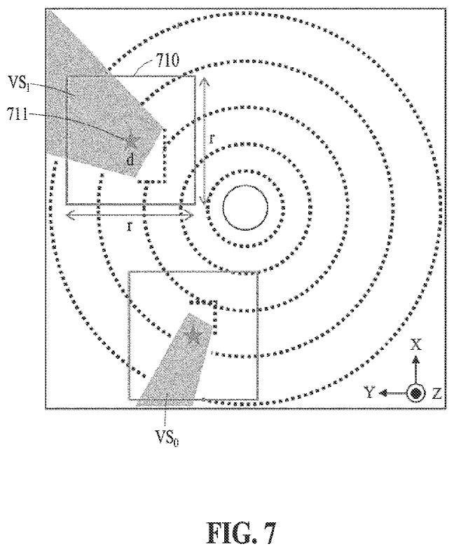

FIG. 7 illustrates an example of a reference area. Referring to FIG. 7, a reference area 710 may be determined based on a shaded region VS₁. The reference area 710 may include at least a portion of the shaded region VS₁. A target point 711 may be determined based on the shaded region VS₁, and the reference area 710 may be determined based on the target point 711. For example, the target point 711 may be determined at a distance equal to a target distance d from the starting point of the shaded region VS₁. The reference area 710 may be determined to include the target point 711 at the center. The size of the reference area 710 may be r×r but is not limited thereto.

Sub-feature data regarding the shaded region VS₁ may be generated using the reference area 710. For example, second sub-feature data corresponding to the reference area 710 may be generated, first sub-feature data corresponding to points in a map image may be generated, and feature data may be generated by merging the second sub-feature data with the first sub-feature data. The second sub-feature data and the first sub-feature data may be generated using a deep learning-based feature extraction model. A deep learning-based object recognition model may generate an object recognition result corresponding to the feature data.

The second sub-feature data may be obtained using the shaded region VS₁, and the first sub-feature data may be obtained using general points. The second sub-feature data may be generated based on a geometric relationship between points in the reference area 710 and the target point 711. The points in the reference area 710 may be referred to as reference points. For example, reference data may be generated based on the geometric relationship between the reference points and the target point 711, and the second sub-feature data may be generated by executing the feature extraction model based on the reference data. When coordinates information (e.g., x value, y value, and z value) and intensity information (e.g., i value) of the reference points are determined and relative coordinates (e.g., Δx value, Δy value, and Δz value) between the reference points and the target point 711 are determined, the reference data may be determined by merging the coordinates information, intensity information, and relative coordinates.

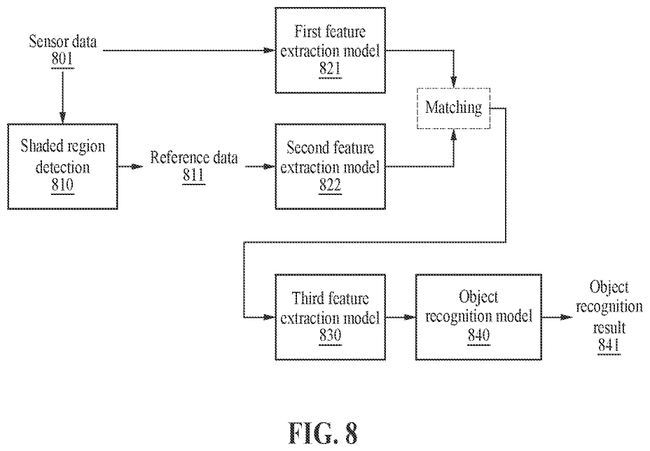

FIG. 8 illustrates an example of a process in which an object recognition result is generated from sensor data. Referring to FIG. 8, sensor data 801 may be obtained from a sensor (e.g., LiDAR). Shaded region detection 810 may be performed based on the sensor data 801, and reference data 811 may be generated based on the shaded region. Points of the sensor data 801 may be voxelized, and the shaded region detection 810 may be performed on the voxelized points. A second feature extraction model 822 may generate sub-feature data corresponding to the reference data 811. The second feature extraction model 822 may be based on a multilayer perceptron (MLP), a transformer, and/or a combination thereof.

A first feature extraction model 821 may generate sub-feature data corresponding to the sensor data 801. The points of the sensor data 801 may be voxelized, and the first feature extraction model 821 may perform feature extraction based on the voxelized points. The sub-feature data generated by the first feature extraction model 821 and the sub-feature data generated by the second feature extraction model 822 may be merged with each other and provided to a third feature extraction model 830. For example, the first feature extraction model 821 may be a three-dimensional (3D) convolutional neural network (CNN). Two-dimensional (2D) feature data may be generated according to a projection operation on the sub-feature data generated by the first feature extraction model 821, and the 2D feature data may be merged with the sub-feature data generated by the second feature extraction model 822.

The third feature extraction model 830 may generate feature data by performing a feature extraction operation. For example, the third feature extraction model 830 may be a 2D CNN. An object recognition model 840 may generate an object recognition result 841 corresponding to the feature data. The first feature extraction model 821, the second feature extraction model 822, the third feature extraction model 830, and the object recognition model 840 may correspond to a deep learning model (e.g., a neural network model). Although the first feature extraction model 821, the second feature extraction model 822, the third feature extraction model 830, and the object recognition model 840 are shown as separate models in FIG. 8, merging at least two of them together may also be possible.

In a training stage, the object recognition result 841 may be compared to ground truth (GT) corresponding to the sensor data 801, and model parameters of the first feature extraction model 821, the second feature extraction model 822, the third feature extraction model 830, and the object recognition model 840 may be adjusted according to the comparison result. When training is completed, the first feature extraction model 821, the second feature extraction model 822, the third feature extraction model 830, and the object recognition model 840 may have the ability to generate the object recognition result 841 corresponding to the sensor data 801.

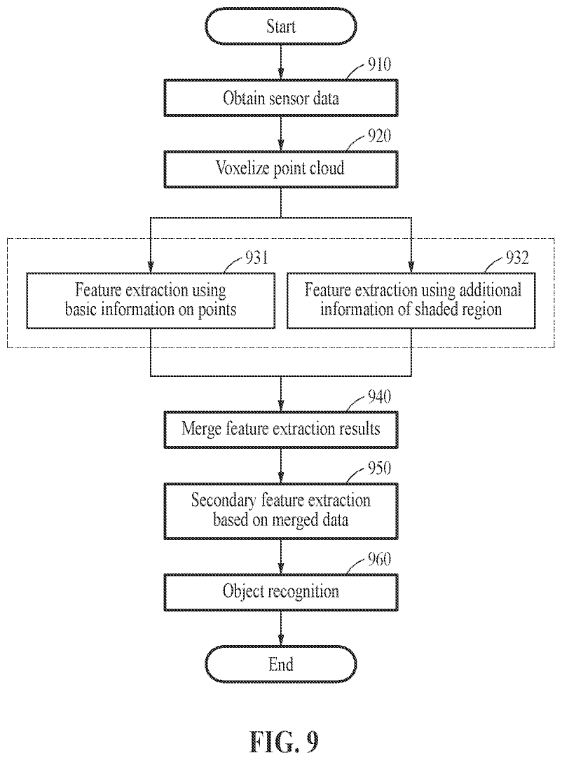

FIG. 9 illustrates an example of an object recognition process based on point voxelization. Referring to FIG. 9, an electronic device may obtain sensor data in operation 910. The sensor data may be obtained from a sensor (e.g., LiDAR). In operation 920, the electronic device may voxelize a point cloud. The sensor data may include the point cloud, and voxelization of points in the point cloud may be performed.

In operation 931, the electronic device may perform feature extraction using basic information on the points. The basic information may include coordinates information and/or intensity information. In operation 932, the electronic device may perform feature extraction using additional information of a shaded region. The additional information may include a geometric relationship between reference points in a reference area of the shaded region and target points in the reference area. Operations 931 and 932 may correspond to primary feature extraction.

In operation 940, the electronic device may merge feature extraction results. In operation 950, the electronic device may perform secondary feature extraction based on merged data. In operation 960, the electronic device may perform object recognition based on a secondary feature extraction result.

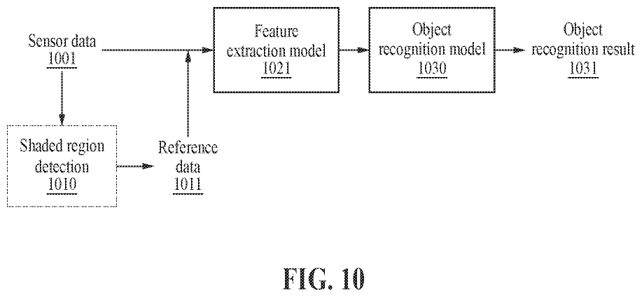

FIG. 10 illustrates an example of a process in which an object recognition result is generated from sensor data. Referring to FIG. 10, sensor data 1001 may be obtained from a sensor (e.g., LiDAR). Shaded region detection 1010 may be performed based on the sensor data 1001, and reference data 1011 may be generated based on a shaded region. Sampling may be performed on points of the sensor data 1001, and the shaded region detection 1010 may be performed according to a sampling result. Sampling may help ensure a uniform distribution of points. The sensor data 1001 may be merged with the reference data 1011 and provided to a feature extraction model 1021. Here, the sampling result of the sensor data 1001 may be merged with the reference data 1011.

The feature extraction model 1021 may generate feature data by performing feature extraction on input data. The feature extraction model 1021 may be based on an MLP, a transformer, and/or a combination thereof. An object recognition model 1030 may generate an object recognition result 1031 corresponding to the feature data. The feature extraction model 1021 and the object recognition model 1030 may correspond to a deep learning model (e.g., a neural network model). Although the feature extraction model 1021 and the object recognition model 1040 are shown as separate models in FIG. 10, merging the two may also be possible.

In a training stage, the object recognition result 1031 may be compared to the GT corresponding to the sensor data 1001, and model parameters of the feature extraction model 1021 and the object recognition model 1030 may be adjusted according to the comparison result. When training is completed, the feature extraction model 1021 and the object recognition model 1030 may have the ability to generate the object recognition result 1031 corresponding to the sensor data 1001.

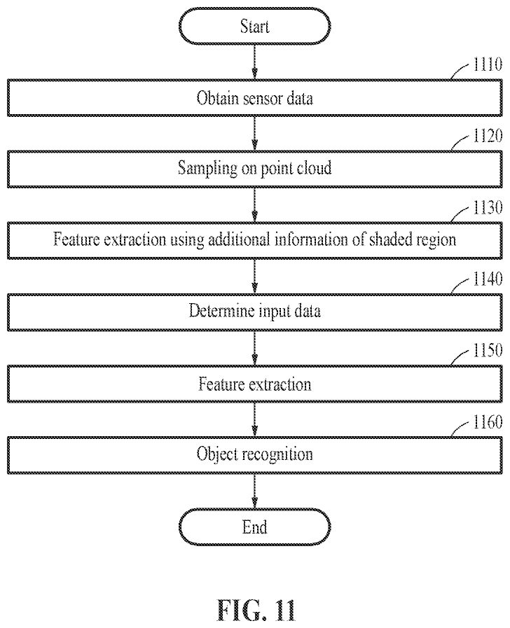

FIG. 11 illustrates an example of an object recognition process based on point sampling. Referring to FIG. 11, in operation 1110, an electronic device may obtain sensor data. The sensor data may be obtained from a sensor (e.g., LiDAR). In operation 1120, the electronic device may perform sampling on a point cloud. Depending on the sampling, unnecessary concentration of points in a map image may be alleviated and points may be naturally and evenly distributed.

In operation 1130, the electronic device may perform feature extraction using additional information of a shaded region. The additional information may include a geometric relationship between reference points in a reference area of the shaded region and target points in the reference area. In operation 1140, the electronic device may determine input data. The electronic device may determine input data by merging a sampling result with the additional information. In operation 1150, the electronic device may perform feature extraction based on the input data. In operation 1160, the electronic device may perform object recognition based on a feature extraction result.

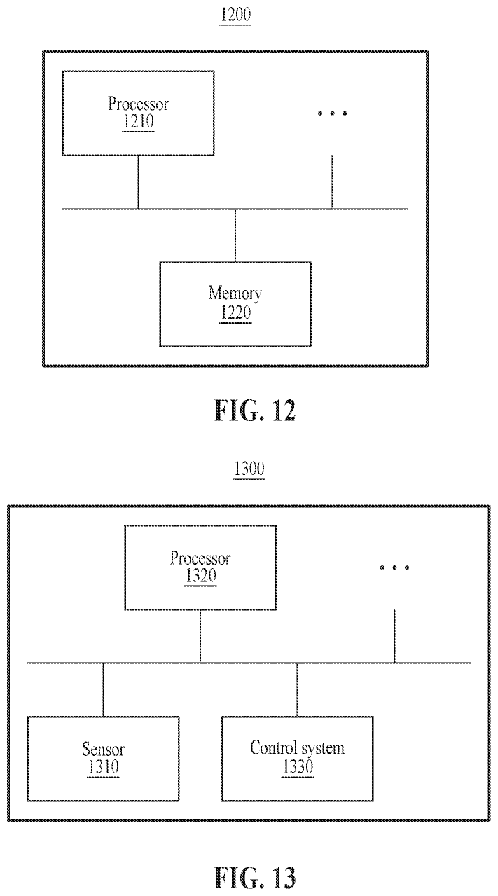

FIG. 12 illustrates an example of a configuration of an electronic device. Referring to FIG. 12, an electronic device 1200 may include a processor 1210 (e.g., one or more processors) and a memory 1220 (e.g., one or memories). Although not shown in FIG. 12, the electronic device 1200 may further include other devices such as a storage device, input device, output device, and network device.

The memory 1220 may be connected to the processor 1210 and may store instructions executable by the processor 1210, data to be computed by the processor 1210, data processed by the processor 1210, and/or a combination thereof. The memory 1220 may include a non-transitory computer-readable medium, for example, high-speed random-access memory, and/or a non-volatile computer-readable storage medium, for example, a disk storage device, flash memory device, and/or other non-volatile solid-state memory devices.

The processor 1220 may execute the instructions for performing the operations described above with reference to FIGS. 1 to 11 and 13. For example, the memory 1220 may include a non-transitory computer-readable storage medium storing instructions that, when executed by the processor 1210, configure the processor 1210 to perform any one, any combination, or all of the operations and/or methods described herein with reference to FIGS. 1 to 11 and 13. For example, when the instructions are executed by the processor 1210, the electronic device 1200 may obtain sensor data including points representing a surrounding environment of a sensor, detect, from the sensor data, a shaded region in which the points are not generated due to occlusion by a surrounding object, generate feature data using the shaded region, and perform object recognition for the surrounding environment of the sensor based on the feature data.

FIG. 13 illustrates an example of a configuration of a vehicle. Referring to FIG. 13, a vehicle 1300 may include a sensor 1310 (e.g., one or more sensors), a processor 1320 (e.g., one or more processors), and a control system 1330. Although not shown in FIG. 13, the vehicle 1300 may further include other devices such as a storage device, input device, output device, network device, and drive system.

The sensor 1310 may generate sensor data including points representing a surrounding environment of the sensor 1310. The processor 1320 may execute instructions for performing the operations described above with reference to FIGS. 1 to 12. A non-transitory computer-readable storage medium may store instructions that, when executed by the processor 1320, configure the processor 1320 to perform any one, any combination, or all of the operations and/or methods described herein with reference to FIGS. 1 to 12. For example, the processor 1320 may detect, from sensor data, a shaded region in which points are not generated due to occlusion by a surrounding object, may generate feature data using the shaded region, and may perform object recognition for the surrounding environment of the sensor 1310 based on the feature data. The control system 1330 may control the vehicle 1300 and/or the drive system based on an object recognition result. For example, the control system 1330 may control the speed and/or steering of the vehicle 1300 according to the object recognition result.

The electronic devices, processors, memories, vehicles, sensors, control systems, electronic device 1200, processor 1210, memory 1220, vehicle 1300, sensor 1310, processor 1320, and control system 1330 described herein, including descriptions with respect to respect to FIGS. 1-13, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-13 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with object recognition, the method comprising:
obtaining sensor data comprising points representing a surrounding environment of a sensor;
detecting, from the sensor data, a shaded region in which the points are not generated due to occlusion by a surrounding object;
generating feature data using the shaded region; and
performing object recognition for the surrounding environment of the sensor based on the feature data.

2. The method of claim 1, wherein the feature data is generated using a reference area comprising at least a portion of the shaded region.

3. The method of claim 1, wherein the generating of the feature data comprises:
determining a reference area comprising at least a portion of the shaded region;
generating second sub-feature data corresponding to the reference area using a deep learning model; and
generating the feature data by merging the second sub-feature data with first sub-feature data corresponding to the points of the sensor data.

4. The method of claim 3, wherein the generating of the second sub-feature data comprises:
determining a target point in the reference area;
generating reference data based on a geometric relationship between reference points in the reference area among the points and the target point; and
generating the second sub-feature data by executing the deep learning model based on the reference data.

5. The method of claim 4, wherein the generating of the reference data comprises:
generating the reference data based on relative coordinates between the reference points and the target point.

6. The method of claim 1, wherein the detecting of the shaded region comprises:
aligning the points according to a distance between a sensor point corresponding to the sensor and each of the points; and
detecting the shaded region based on either one or both of a change in elevation of the points and an interval between the points.

7. The method of claim 1, wherein the detecting of the shaded region comprises:
dividing a virtual space corresponding to the surrounding environment of the sensor into segments;
determining shaded region candidates having a possibility to be the shaded region based on the segments; and
determining the shaded region based on the shaded region candidates.

8. The method of claim 7, wherein the determining of the shaded region candidates comprises:
aligning the points according to a distance between a sensor point corresponding to the sensor and each of the points;
determining starting points based on either one or both of a change in elevation of the points and an interval between the points; and
determining the shaded region candidates in, among the segments, segments in which the starting points are included.

9. The method of claim 8, wherein the determining of the shaded region comprises:
determining the shaded region by merging two or more of the shaded region candidates based on a geometric relationship between the starting points.

10. The method of claim 9, further comprising determining a distance between the sensor point and a starting point of the shaded region based on an average of distances between the sensor point and starting points of the two or more of the shaded region candidates.

11. A non-transitory computer-readable storage medium storing instructions that, when executed by one or more processors, configure the one or more processors to perform the method of claim 1.

12. An electronic device comprising:
one or more processors configured to:
obtain sensor data comprising points representing a surrounding environment of a sensor;
detect, from the sensor data, a shaded region in which the points are not generated due to occlusion by a surrounding object;
generate feature data using the shaded region; and
perform object recognition for the surrounding environment of the sensor based on the feature data.

13. The electronic device of claim 12, wherein the feature data is generated using a reference area comprising at least a portion of the shaded region.

14. The electronic device of claim 12, wherein, for the generating of the feature data, the one or more processors are configured to:
determine a reference area comprising at least a portion of the shaded region;
generate second sub-feature data corresponding to the reference area using a deep learning model; and
generate the feature data by merging the second sub-feature data with first sub-feature data corresponding to the points of the sensor data.

15. The electronic device of claim 14, wherein, for the generating of the second sub-feature data, the one or more processors are configured to:
determine a target point in the reference area;
generate reference data based on a geometric relationship between reference points in the reference area among the points and the target point; and
generate the second sub-feature data by executing the deep learning model based on the reference data.

16. The electronic device of claim 12, wherein, for the detecting of the shaded region, the one or more processors are configured to:
align the points according to a distance between a sensor point corresponding to the sensor and each of the points; and
detect the shaded region based on either one or both of a change in elevation of the points and an interval between the points.

17. The electronic device of claim 12, wherein, for the detecting of the shaded region, the one or more processors are configured to:
divide a virtual space corresponding to the surrounding environment of the sensor into segments;
determine shaded region candidates having a possibility to be the shaded region based on the segments; and
determine the shaded region based on the shaded region candidates.

18. The electronic device of claim 17, wherein, for the determining of the shaded region candidates, the one or more processors are configured to:
align the points according to a distance between a sensor point corresponding to the sensor and each of the points;
determine starting points based on either one or both of a change in elevation of the points and an interval between the points; and
determine the shaded region candidates in, among the segments, segments in which the starting points are included.

19. The electronic device of claim 18, wherein, for the determining of the shaded region, the one or more processors are configured to:
determine the shaded region by merging two or more of the shaded region candidates based on a geometric relationship between the starting points.

20. A vehicle comprising:
a sensor configured to generate sensor data comprising points representing a surrounding environment of a sensor;
one or more processors configured to:
detect, from the sensor data, a shaded region in which the points are not generated due to occlusion by a surrounding object;
generate feature data using the shaded region; and
perform object recognition for the surrounding environment of the sensor based on the feature data; and
a control system configured to control the vehicle based on a result of the object recognition.
